(19) United States
(12) Patent Application Publication
(10) Pub. No.: US 2013/0264323 A1
(43) Pub. Date: Oct. 10, 2013

(54) PROCESS FOR SURFACE TENSION TRANSFER SHORT CIRUIT WELDING

(71) Applicant: Joseph A. Daniel, Sagamore Hills, OH (US)

(72) Inventor: Joseph A. Daniel, Sagamore Hills, OH (US)

(73) Assignee: LINCOLN GLOBAL, INC., City of Industry, CA (US)

(21) Appl. No.: 13/440,623

(22) Filed: Apr. 5, 2012

(51) Int. Cl. B23K 9/09

(52) U.S. Cl. 219/137 PS

(57) ABSTRACT

The invention described herein generally pertains to a method for improved necking detection of weld beads in welding processes involving surface tension transfer short circuit welding in which at least one threshold value which is used to detect the event of necking is dynamically updated for each welding cycle in a welding waveform based on characteristics of the preceding cycle.

### TECHNICAL FIELD

The invention described herein pertains generally to a method for improved necking detection of weld beads in for welding processes involving surface tension transfer short circuit welding.

### BACKGROUND OF THE INVENTION

In consumable electrode arc welding, one of the recognized modes of operation is the short circuiting mode, wherein a power supply is connected across the consumable electrode, or welding wire, and the workpiece onto which a weld bead is to be deposited. As an arc is created, the end of the electrode melts to form a globular mass of molten metal hanging on the electrode and extending toward the workpiece. When this mass of molten material becomes large enough, it bridges the gap between the electrode and the workpiece to cause a short circuit. At that time, the voltage between the electrode and the workpiece drops drastically thereby causing the power supply to increase the current through the short circuit. Such high current flow is sustained and is actually increased with time through the molten mass. Since this short circuit current continues to flow, an electric pinch necks down a portion of the molten mass adjacent the end of the welding wire. The force causing the molten welding wire to neck down is proportional to the square of the current flowing through the molten metal at the end of the welding wire. This electric pinch effect is explained by the Northrup equation:

$$G ( \frac{dynes}{{cm}^{2}} ) = \frac{{I}^{2} ( {R}^{2} - {r}^{2} )}{100 π {R}^{4}}$$

wherein I is current, r is the distance from the center of the welding wire and R is the diameter of the neck. During the short circuit, there is a need for a relatively high current flow. This high current flow is desirable to cause the neck portion of the molten mass to form rapidly into a very small area or neck which ultimately explodes like an electric fuse to separate the molten ball from the wire and allow it to be drawn into the weld pool by surface tension. This explosion of the neck causes spatter from the welding process. Spatter is deleterious to the overall efficiency of the welding operation and requires a substantial amount of cleaning adjacent the weld bead after the welding operation is concluded. Since the current flow through the wire or rod to the workpiece when the neck or fuse explodes is quite high, there is a tremendous amount of energy released by the neck explosion adding to the propelled distance and amount of spatter.

As can be seen, there is contradiction between the short circuit current which should be high to efficiently decrease the neck size by an electric pinch, but should be low to reduce the energy of the fuse explosion and, correspondingly, reduce the spatter and distance over which the spatter particles will be propelled.

A considerable amount of effort has been devoted to limiting spatter when the arc is reestablished by the explosion at the neck or fuse of the metal ball hanging from the welding wire and engaging the workpiece or weld pool. At first, it was suggested to reduce the diameter of the welding wire, i.e. use a 1/32 wire; however, this approach to reducing spatter caused all of the inefficiencies normally associated with using small welding wire. For instance, it was difficult to lay large amounts of weld bead. As the wire diameter increased to overcome these problems, spatter was substantially increased. Faced with this dilemma, it was suggested that a high frequency power supply be used wherein a high frequency inverter is turned off during a short circuiting condition or upon detection of a premonition of re-arcing, i.e. blowing of the fuse. When the high frequency power supply is turned off just before fuse explosion, a switch is employed which is opened to place a resistor in the output tank circuit of the solid state inverter for rapid attenuation of the current. This system is not applicable for all power supplies and is predicated upon a complex logic control system which actually forms the shape of the current curve from the time a short is detected to the time when the arc is reestablished after explosion of the neck or fuse. Reduction of the current at the time of a short (or formation of the arc) is by tuned attenuation. At the detection of a neck or fuse which is about to blow, this same attenuation concept is employed. The preselected wave shape is heavily reliant upon the aforementioned attenuation of the output tank circuit of a solid state inverter which is a serious limitation especially in reducing the current flow through the neck itself at the moment of explosion. Such a preselected current shaping is applicable, to high frequency solid state inverter power supplies which can be internally turned off. With a substantial inductive reactance in the output circuit attenuation by the resistor in parallel with the switch would be difficult and not always guaranteed. Since direct current welding systems have output inductance this attenuation concept for lowering spatter has serious practical drawbacks and is additionally limited to static threshold values from lookup tables or a welder's experience based upon setup conditions e.g., cable lengths, and user adjusted conditions, e.g., contact tip to work distance.

Therefore, it is easily seen that what is needed is a dynamic way to adjust the threshold value to the actual welding conditions being experienced in real time to provide a more accurate detection method for detection of the end of a shorting event. Improved detection has the highly desirable effect of reducing spatter, particularly by eliminating missed detections that can cause heavy shorting in addition to larger amounts of spatter, and a more stable welding process.

### SUMMARY OF THE INVENTION

In accordance with the present invention, there is provided a process for dynamically adjusting a threshold value for detecting the end of a short circuit condition during a welding operation comprising the steps of: monitoring at least one welding parameter associated with a waveform for a short circuit transfer welding process; comparing the at least one welding parameter to a threshold value for the at least one welding parameter; adjusting a value of the threshold value based on the step of comparing; and using the adjusted value as a new threshold value for the next cycle of the waveform. The process may further include the step of generating at least one action to correct a welding issue when the step of comparing determines that the threshold value is either too high or too low. The monitored at least one welding parameter is selected from the group consisting of current, voltage, time, resistance, power, power density and derivatives thereof. In implementing the process, the step of adjusting uses a controller selected from the group consisting of a proportional controller, a proportional-integral controller, a proportional-derivative controller, and a proportional-integral-derivative controller, preferably, a proportional-integral-derivative controller. In further implementing the process, the step of generating at least one action to correct a welding issue may include reigniting an arc by a plasma boost. To start the sequence, an initial threshold value is predefined and a new threshold value is dynamically updated based on said step of using.

In one implementation of the technology, the monitored parameter is voltage or a derivative of voltage in that it is important to reduce the current just prior to the completion of the necking event. In another implementation of the technology, the monitored parameter is resistance or a derivative of resistance in that the resistance value will increase as the necking cross-sectional area decreases. In yet another implementation of the technology, the monitored parameter is power density or a derivative of power density in that as the radius of the necking area approaches zero, the power density increases toward infinity.

In accordance with the present invention, there is provided a process for dynamically adjusting a threshold value for detecting the end of a short circuit condition during a welding operation comprising the steps of: monitoring at least one welding parameter associated with a waveform for a short circuit transfer welding process; comparing the at least one welding parameter to a threshold value for the at least one welding parameter; adjusting a value of the threshold value based on the step of comparing wherein the adjusting is in accordance with the following logic:
If Time to arc reestablishment_{(detected)}>Time to arc reestablishment_{(defined)},
   then Threshold Detection Value=Threshold Detection Value+Δ
If Time to arc reestablishment_{(detected)}<Time to arc reestablishment_{(defined)},
   then Threshold Detection Value=Threshold Detection Value−Δ
If Time to arc reestablishment_{(detected)}=Time to arc reestablishment_{(defined)},
   then Threshold Detection Value=Threshold Detection Value+0;
      and wherein

Time to arc reestablishment_{(detected)}=the detected or measured value of time between the completion of electrode necking or fuse separation (T₃ of FIG. 4) to reestablishment of the welding arc (T₄ of FIG. 4);

Time to arc reestablishment_{(defined)}=the targeted time difference between T₃ and T₄ of FIG. 4, e.g., 50 microseconds or some other targeted time value;

Threshold Detection Value=present value of the detection threshold parameter, e.g., dv/dt, ohms, voltage or other appropriate parameter used to detect the completion of electrode necking (T₃ of FIG. 4);

Δ=adjustment value for the Threshold Detection Value parameter, e.g., dv/dt, ohms, voltage, time or other appropriate parameter as calculated by modification of the value in a manner discussed below through utilization of a PID controller and the magnitude of the difference of the actual value of the time measurement to arc reestablishment, T_{(detected)} when compared to the targeted or defined value, T_{(defined)} (e.g., 50 microseconds).

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a combined block diagram and wiring diagram illustrating an electric arc welder for performing a pulse welding process employing a feedback circuit operating in real time to influence the threshold detection value for the waveform based on the preceding welding event;

FIG. 2 is a graph illustrating a voltage curve and current curve of a prior art pulse welding process;

FIG. 3 is a graph illustrating the signals of various locations in the electric arc welder illustrated in FIG. 1;

FIG. 4 is a waveform similar to FIG. 3 depicting current vs. time and associating it with weld bead formation, necking and ultimate deposition into a weld puddle; and

FIG. 5 is a flow diagram of the decisions applicable to each threshold value as dynamically adjusted and employed in the next cycle of the waveform.

### DETAILED DESCRIPTION OF THE INVENTION

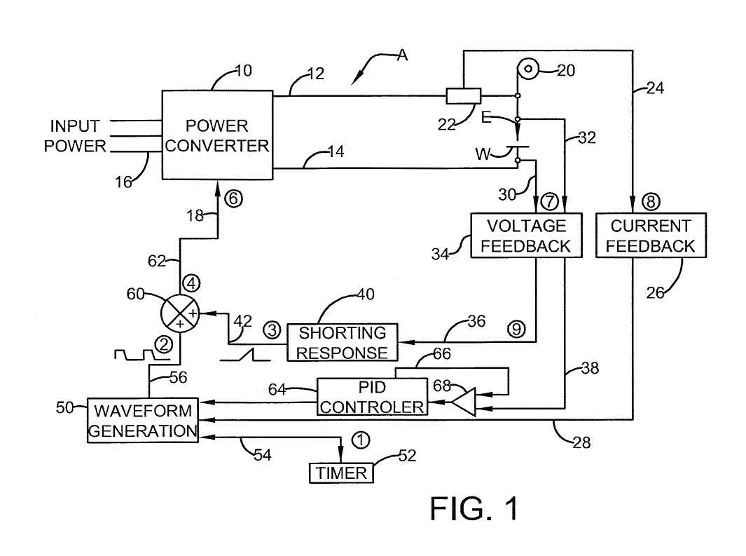

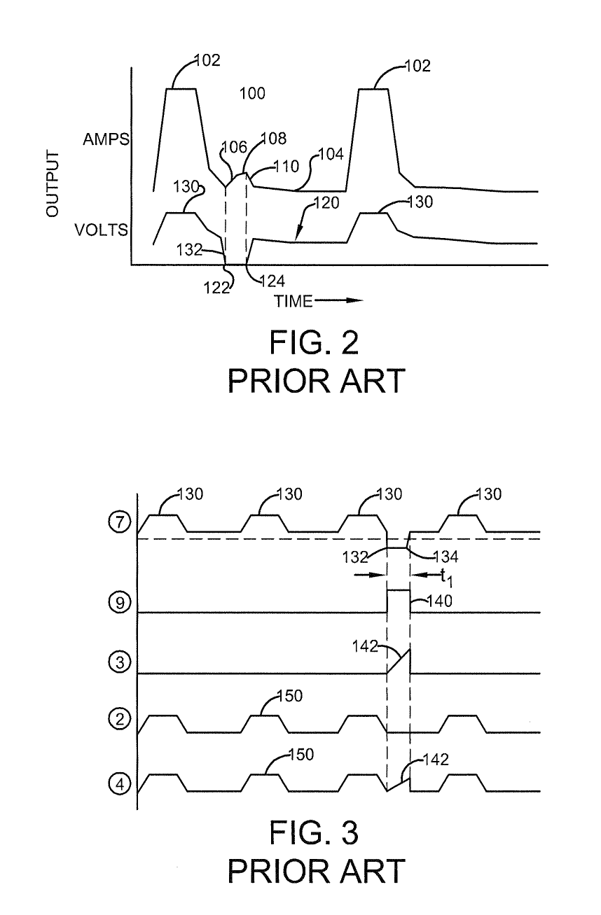

The best mode for carrying out the invention will now be described for the purposes of illustrating the best mode known to the applicant at the time of the filing of this patent application. The examples and figures are illustrative only and not meant to limit the invention, which is measured by the scope and spirit of the claims. Referring now to the drawings, wherein the showings are for the purpose of illustrating an exemplary embodiment of the invention only and not for the purpose of limiting same, FIG. 1 illustrates an electric arc welder A for performing a pulse welding process, as shown in FIG. 2. Although other welder architectures could be used, an exemplary architecture is a welder controlled by waveform technology as pioneered by The Lincoln Electric Company of Cleveland, Ohio. In this type of welder, a waveform generator produces the profile for the waveforms used in a pulse welding process. The power source creates the pulses in accordance with the shape determined from the waveform generator by using a plurality of current pulses and at high frequency such as over 18 kHZ. This type of technology produces precise pulse shapes for any desired welding process. Even though the invention will be described with respect to the use of a welder employing waveform technology, the invention is broader and may be used in other welders, such as SCR (Silicon Controlled Rectifier) controlled welders and chopper based welders.

Electric arc welder A shown in FIG. 1 is used to perform a standard pulse welding process as illustrated by the curves in FIG. 2 with a plurality of operating signals indicated at various locations in FIG. 1 and by corresponding numbers in FIG. 3. Electric arc welder A has a power source 10 in the form of a high speed switching inverter with output leads 12, 14 for creating the pulse welding process between electrode E and workpiece W. Power source 10 is driven by an appropriate power supply 16, illustrated as a three phase input. The profile of the pulses and separating background current constituting the pulse welding process is determined by a signal on wave shape input 18. Current shunt 22 communicates the arc current of the welding process by lines 24 to current sensor 26 having an analog output 28 used for a feedback control loop. In a like manner, leads 30, 32 communicate the arc voltage to voltage sensor 34 having a detect output 36 and a level or amplitude output 38. The detect output indicates when the level of voltage plunges during a short circuit between electrode E and workpiece W. Level output 38 has a signal representative of the arc voltage across the electrode and workpiece. Voltage detect output 36 is directed to a shorting response circuit 40 having a shorting response output 42 which outputs a signal 3. When there is a short circuit, there is a shorting response in line 42 in accordance with standard technology. Waveform generator 50 is loaded with the particular waveform to perform the welding process. This waveform is indicated as signal 2. Timer 52 directs a timing signal by lines 54 to waveform generator for the purpose of initiating the individual pulses constituting the welding process. Generator 50 also has feedback signals from lines 28, 38 to control the voltage and current in accordance with the set profile of the waveform generator and the existing profile between the electrode and workpiece. The waveform that is to be outputted by power source 10 is signal 2 in line 56. This signal is connected to the input of summing junction or adder 60 having an output 62 for signal 4. This signal, in welder A, is the actual signal directed to input 18 of power source 10.

The welding process performed by welder A is illustrated in FIG. 2 wherein current curve 100 has a series of spaced current pulses 102 separated by background current portion 104. Voltage curve 120 is the voltage between lines 30, 32 and constitutes the arc voltage correlated with the arc current of curve 100. The peak voltage is a result of applying peak current 102. A low average voltage of curve 120 is due to a high instantaneous arc voltage average with a shorting signal at or below about 6.0 volts. When there is a short circuit, arc voltage 120 plunges as indicated by point 122. This voltage plunge indicates a short circuit of molten metal between the electrode and workpiece. When that occurs, a clearing procedure overrides the waveform shape in line 56. Upon detection of a short circuit at point 122, a high current is applied between the electrode and workpiece along ramp 106 shown in FIG. 2. In practice, this ramp is steep and then becomes gradual as indicated by portion 108. When the short circuit is cleared by the increased current, in accordance with standard technology, the voltage of curve 120 immediately shifts back to a plasma or arc condition. This causes a tail out or recovery of the current along line 110. Consequently, when there is a short circuit, arc current is increased along ramp 106 and ramp 108 until the short is cleared, as indicated by an increased voltage. This removal of the short circuit, stops the output of shorting response circuit 40.

The operation of welder A is disclosed by the signals 2, 3, 4, 7 and 9 as shown in FIG. 3. Signal 7 is the sensed voltage in line 36. Under normal circumstances, voltage 120 includes a plurality of spaced pulses 130 having shapes determined by waveform generator 50 and spacing determined by timer 52. When there is a short at point 122, the voltage plunges along line 132. This causes a pulse 140 that generates an output in line 42 which output is in the form of signal 142 generally matching ramp 106 and 108 for the current curve 100 that is added to signal 2. The output of waveform generator 50 is signal 2 constituting the waveform signal 150 shown in FIG. 3. The output of summing junction 60 in line 62 is the summation of signals 2 and 3 which is shown as signal 4 in line 62. Ramp 142 is added to waveform 150 so that the output between electrode E and workpiece W is the signal in lines 18 & 62 controlling the inverter type power source 10.

The invention relates to a welding mode such as Surface Tension Transfer® or STT® welding mode in which metal transfer is a low heat input welding mode. The STT welding mode is reactive. The power source monitors the arc and responds instantaneously to the changes in the arc dynamics. A sensing lead attaches to the workpiece to provide feedback information to the power source. Uniquely, the STT power source provides current to the electrode independent of the wire feed speed. This feature permits the ability to add or reduce current to meet application requirements.

The power source that supports STT is neither constant current nor constant voltage. It provides controls for the essential components of the STT waveform. Among these are controls for peak current, background current and tail-out current.

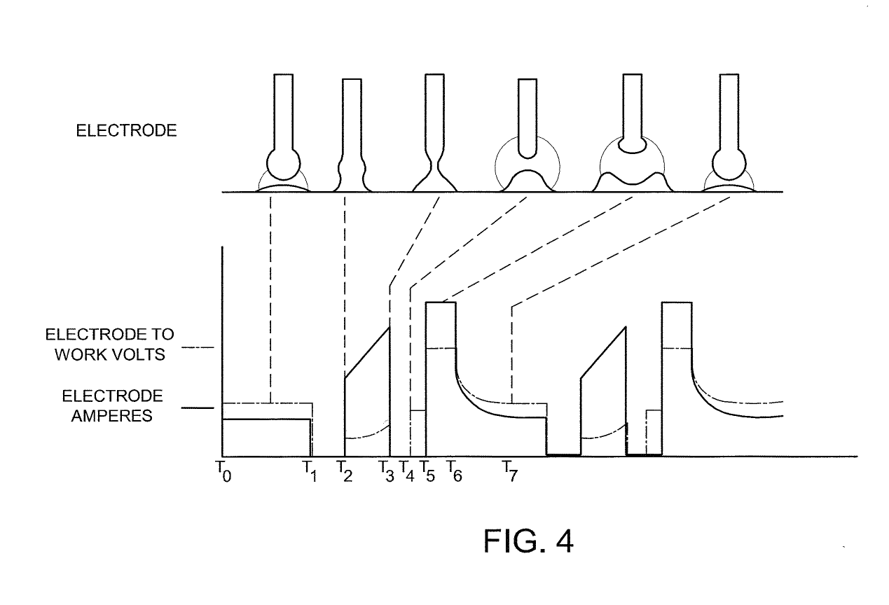

As illustrated in FIG. 4, between times T₀-T₁, STT produces a uniform molten ball and maintains it until the “ball” shorts to the puddle. The molten tip of the electrode makes initial physical contact with the molten pool at the background current level (T₀-T₁) between 50-100 amps. At time T₁, (at the background current), the voltage sensing clip reads a decrease in voltage and the machine drops the amperage. The background current is further reduced to 10 amperes for approximately 0.75 milliseconds. This time interval is referred to as the ball time (T₁-T₂). The reduction in current is to prevent the occurrence of a premature molten droplet detachment.

During pinch mode, (T₂-T₃), the wire is still being fed, therefore, fusion is occurring between the electrode with the workpiece. In order to transfer the molten drop, the current quickly ramps up to a point where the pinch force associated with the rise in current (electromagnetic force) starts to neck down the molten column of the electrode. At this time, as illustrated in FIG. 1, the power source begins to monitor the changes in voltage over time as it relates to the necking of the molten droplet. The molten metal is still in contact with the molten weld pool. Via the sensing lead, the power source references the observed voltage and continuously compares the new voltage value to the previous voltage value. At T₃, the wire begins to “neck” down. While voltage is the measured parameter in this illustration, there is no need to limit the invention to such. In fact, any measured parameter is applicable, a non-limiting exemplary list including resistance, amperage, power, in their original or derivative forms.

During times T₂-T₃, the dv/dt calculation occurs indicating the moment before the wire completely detaches. It is the first derivative calculation of the rate of change of the shorted electrode voltage vs. time. When this calculation indicates that a specific dv/dt value has been attained, indicating that fuse separation is about to occur, the current is reduced again to 50 amperes in a few microseconds. This is to prevent a violent separation and explosion that would create spatter. This event occurs before the shorted electrode separates.

At the point where the molten metal is about to disconnect from the end of the electrode, time T₃, the power source reduces the current to a lower than background current level of approximately 45-50 amps. At this point in the wave form, the molten droplet transfers to the weld pool. This controlled detachment of the molten droplet is essentially free of spatter if the threshold value is defined correctly.

The power source raises the peak current level between times T₄-T₅, and a new droplet begins to form at times T₅-T₆. A plasma boost is applied which provides the energy to re-establish the arc length, provide a new molten droplet, and force the molten puddle away from the molten droplet. The length of time is nominally 1 millisecond for carbon steel electrodes and 2 milliseconds for both stainless steel and nickel-alloyed filler metals. Anode jet forces depress the molten weld puddle to prevent it from reattaching to the electrode. It is at this period of high arc current that the electrode is quickly “melted back”. During the period, T₆-T₇, the arc current is reduced from plasma boost to the background current level. In the tail-out period, the current provides the molten droplet with additional energy as the current returns to its initial background level. The added energy increases puddle fluidity, and the result is improved wetting at the toes of the weld.

As used above, peak current is responsible for establishing the arc length, and it provides sufficient energy to preheat the workpiece to insure good fusion. If it is set too high, the molten droplets will become too large. Background current is the essential component responsible for providing weld penetration into the base material, and it is largely responsible for the overall heat input into the weld. Manipulation of this component controls the level of weld penetration, and it effects the size of the molten droplet. Tail-out current is responsible for adding energy to the molten droplet to provide increased droplet fluidity. Increasing the tail-out current permits faster travel speeds and improves weld toe wetting action. The use of tail-out has proven to be a great value in increasing puddle fluidity and this translates into higher arc travel speeds.

However, the detection of time T₃ as represented in FIG. 4, is neither constant, nor trivial. One aspect of this invention focuses on a proper detection of time T₃ associated with the necking phenomena and dynamically using that information to adjust the dv/dt threshold value for the next cycle in the welding process. When the dv/dt detection properly identifies bead necking and reduces the current to a very low level just prior to separation, spatter is avoided. After waiting a relatively short amount of time (e.g., 20-30 microseconds), the necking separation is expected to occur at which time the welding arc is reestablished. Following the creation of this welding arc, the current is increased to form a new droplet and repeat the cycle.

However, when the dv/dt threshold value is incorrect for the given conditions, two possible outcomes are possible: the threshold value is set too high or the threshold value is set too low. When the threshold detection value is too low, the dv/dt detection is too early during the necking process. This leads to a premature drop in current and the necking separation does not occur within an maximum waiting period. After a defined maximum waiting period (e.g., 100-200 microseconds), the short clearing function is repeated (current is ramped up to complete the necking separation and reignite the arc and start the next cycle). The result is that the next cycle of the waveform is dynamically adjusted to use a higher threshold value through the interface with the controller. Through dynamic adjustment of the threshold value, arc instability is reduced as well as the loss of heat as the wire is continuing to feed but the process is “stuck” in a shorted condition longer than expected. In this scenario described in this paragraph, and with further reference to FIG. 1, an initial threshold value is assigned to reference signal 66. This initial assignment is done via software, or employs the last detected value, or is set by operator experience, or is defined based upon operator input into the software based on the type of welding which is to be used, the inert gas employed, welding wire feed rate, etc. When the measured threshold value (specifically the voltage or derivative thereof, as detected along line 38) is greater than the current threshold detection value, as compared by comparator 68, then controller 64 increases the value for the next threshold value for use in the subsequent comparison as well as in the waveform generator 50. The increased threshold value dynamically becomes the new threshold comparative value.

When the threshold detection value is too high, the dv/dt detection never occurs and the current is never reduced. Therefore, at necking, the amount of current is too high, resulting in spatter. Through dynamic adjustment of the threshold value, the next cycle uses a lower threshold value through the interface with the controller. In this scenario, and with further reference to FIG. 1, the measured threshold value (specifically the voltage or derivative thereof, as detected along line 38) is less than the threshold detection value from the previously detected value of the threshold (specifically the previous voltage or derivative value represented by reference line 66), as compared by comparator 68, then controller 64 decreases the value for the next threshold value for use in the subsequent comparison as well as in the waveform generator 50. The reduced threshold value dynamically becomes the new threshold comparative value.

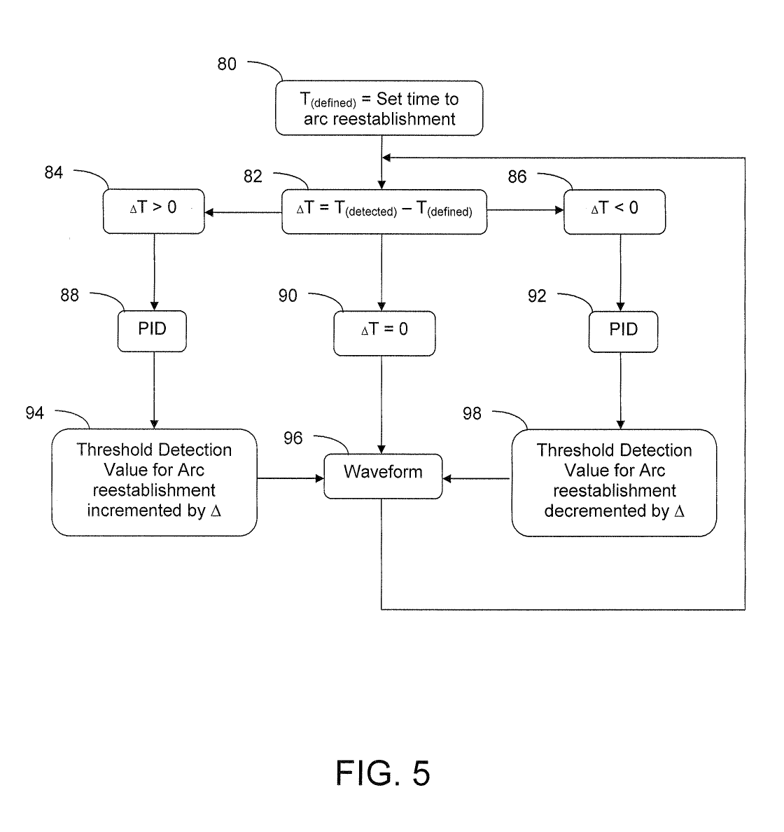

Sequentially, the following occurs as illustrated in the decision tree flow diagram of FIG. 5. An initial time is defined for arc reestablishment, T_{(defined)} of reference block 80, based upon operator knowledge, software pre-selection based on welding wire characteristics and welding type, or some other method known in the art. This initial arc reestablishment time is compared against the detected value, T_{(detected)}, for the arc reestablishment time of reference block 82, and in which dynamic adjustment of the threshold detection Threshold Value is adjusted in accordance with the following logic:
If Time to arc reestablishment_{(detected)}>Time to arc reestablishment_{(defined)} (reference block 84),
   then Threshold Detection Value=Threshold Detection Value+Δ (reference block 94) after mathematical processing via a PID controller (reference block 88),
If Time to arc reestablishment_{(detected)}<Time to arc reestablishment_{(defined)} (reference block 86),
   then Threshold Detection Value=Threshold Detection Value−Δ (reference block 98) after mathematical processing via a PID controller (reference block 92),
If Time to arc reestablishment_{(detected)}=Time to arc reestablishment_{(defined)} (reference block 90),
   then Threshold Detection Value=Threshold Detection Value+0;

Time to arc reestablishment_{(detected)}=the detected or measured value of time between the completion of electrode necking or fuse separation (T₃ of FIG. 4) to reestablishment of the welding arc (T₄ of FIG. 3);

Time to arc reestablishment_{(defined)} (reference block 80)=the targeted time difference between T₃ and T₄ of FIG. 4, e.g., 50 microseconds or some other targeted time value;

Threshold Value=present value of the detection threshold parameter, e.g., dv/dt, ohms, voltage or other appropriate parameter used to calculate the detection of the completion of electrode necking (T₃ of FIG. 4);

Δ=adjustment value for the detection threshold parameter, e.g., dv/dt, ohms, voltage or other appropriate parameter as calculated by modification of the value in a manner discussed below through utilization of a PID controller and the magnitude of the difference of the value of the time measurement to arc reestablishment when compared to the targeted or defined value (e.g., 50 microseconds); and

ΔT=the time difference between the Time to arc reestablishment_{(detected)} minus the Time to arc reestablishment_{(defined or targeted)} (reference block 82).

Phrased equivalently, if the amount of time which transpired between the completion of necking and the reigniting of the arc was 75 microseconds, with a 50 microsecond targeted value, then the threshold detection value (which could be a derivative of voltage (e.g., dv/dt), or voltage (volts), or power (watts) or resistance (ohms) or other suitable parameter) would be increased by a value of Δ. This incremental value would increase the present threshold value by operation of a PID controller calculation which would raise the present value of the threshold detection parameter to a higher value for use in the subsequent cycle of the waveform. For example, in this scenario, if the initial threshold value was defined as “x” volts (or equivalently “x” watts or equivalently “x” ohms or equivalently “x” dv/dt units), and the time for arc reignition was too long, then the threshold value would need to be incrementally increased preferentially through the application of a proportional, integral and derivative calculation, (e.g., “x”+“y” volts) by a value “y” as determined by the PID controller based upon the degree of difference in the arc reignition time values. Equivalently, this could be expressed in other units, e.g., “x”+“y” ohms or “x”+“y” watts.

Based on the outcome of the comparison of actual detected time to defined time for the reestablishment of the welding arc, a new threshold value is dynamically employed in the next cycle of the waveform to ensure that spatter is minimized. As defined above but applicable to this repeating decision sequence, Δ is a dynamic adjustment value for each instantaneous calculation of how far apart the predefined or targeted arc reestablishment time is from the detected time. Simultaneously, supplemental information is sent to resolve the issues attendant to a threshold system imbalance, as defined previously for each cycle of the waveform. This process is repeated for the duration of the welding operation, for each cycle of the welding waveform.

In a preferred embodiment, controller 64 is a PID controller (Proportional Integral Derivative controller). Proportional means that there is a linear relationship between two variables. Proportional control is an excellent first step, and will reduce, but never eliminate, the steady-state error and typically results in an overshoot error. To improve the response of a proportional controller, integral control is often added. The integral is the running sum of the error. Therefore, the proportional controller tries to correct the current error and the integral controller attempts to correct and compensate for past errors. The derivative controller attempts to predictively correct error into the future. That means that the error is expected to be the current error plus the change in the error between the two preceding sensor sample values. The change in the error between two consecutive values is the derivative. While a PID controller is preferred, the STT system will benefit from the use of just a proportional controller, a proportional-integral controller, or a proportional-derivative controller.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A process for dynamically adjusting a threshold value for detecting the end of a short circuit condition during a welding operation comprising the steps of:
monitoring at least one welding parameter associated with a waveform for a short circuit transfer welding process;
comparing said at least one welding parameter to a threshold value for said at least one welding parameter;
adjusting a value of said threshold value based on said step of comparing; and
using said adjusted value as a new threshold value for a next cycle of said waveform.

2. The process of claim 1 which further comprises the step of
generating at least one action to correct a welding issue when said step of comparing determines that said threshold value is either too high or too low.

3. The process of claim 1 wherein
said at least one welding parameter is selected from the group consisting of current, voltage, time, resistance, power, power density and derivatives thereof.

4. The process of claim 1 wherein
said step of adjusting uses a controller selected from the group consisting of a proportional controller, a proportional-integral controller, a proportional-derivative controller, and a proportional-integral-derivative controller.

5. The process of claim 4 wherein
said step of adjusting uses a proportional-integral controller.

6. The process of claim 2 wherein
said step of generating at least one action to correct a welding issue comprises reigniting an arc by a plasma boost.

7. The process of claim 1 wherein
an initial threshold value is predefined and a new threshold value is dynamically updated based on said step of using.

8. The process of claim 3 wherein
said at least one welding parameter is selected from the group consisting of voltage and a derivative of voltage.

9. The process of claim 3 wherein
said at least one welding parameter is selected from the group consisting of resistance and a derivative of resistance.

10. The process of claim 3 wherein
said at least one welding parameter is selected from the group consisting of power and a derivative of power.

11. A process for dynamically adjusting a threshold value for detecting the end of a short circuit condition during a welding operation comprising the steps of:
monitoring at least one welding parameter associated with a waveform for a short circuit transfer welding process;
comparing said at least one welding parameter to a threshold value for said at least one welding parameter;
adjusting said threshold value based on said step of comparing, wherein said adjusting is in accordance with the following logic:
If Time to arc reestablishment_{(detected)}>Time to arc reestablishment_{(defined)},
then Threshold Detection Value=Threshold Detection Value+Δ;
If Time to arc reestablishment_{(detected)}21 Time to arc reestablishment_{(defined)},
then Threshold Detection Value=Threshold Detection Value−Δ;
If Time to arc reestablishment_{(detected)}=Time to arc reestablishment_{(defined)},
then Threshold Detection Value=Threshold Detection Value+0;
wherein
Time to arc reestablishment_{(defined)} is a defined or targeted value of time for the detection of arc reestablishment
Time to arc reestablishment_{(detected)} is the actual detected value of time for arc reestablishment;
Threshold Detection Value=setpoint for the threshold detection; and
Δ is an adjustment value for the Threshold Detection Value; and
using said adjusted Threshold Detection Value as a new Threshold Detection Value for a next cycle of said waveform.

12. The process of claim 11 which further comprises the step of
generating at least one action to correct a welding issue when said step of comparing determines that said threshold value is either too high or too low.

13. The process of claim 11 wherein
said at least one welding parameter is selected from the group consisting of current, voltage, time, resistance, power, power density and derivatives thereof.

14. The step of claim 11 wherein
said step of adjusting uses a controller selected from the group consisting of a proportional controller, a proportional-integral controller, a proportional-derivative controller, and a proportional-integral-derivative controller.

15. The step of claim 14 wherein
said step of adjusting uses a proportional-integral controller.

16. The step of claim 12 wherein
said step of generating at least one action to correct a welding issue comprises reigniting an arc by a plasma boost.

17. The step of claim 11 wherein
an initial threshold value is predefined and a new threshold value is dynamically updated based on said step of using.

18. The process of claim 13 wherein
said at least one welding parameter is selected from the group consisting of voltage and a derivative of voltage.

19. The process of claim 13 wherein
said at least one welding parameter is selected from the group consisting of resistance and a derivative of resistance.

20. The process of claim 13 wherein
said at least one welding parameter is selected from the group consisting of power and a derivative of power.
